(19) United States
(12) Patent Application Publication
(10) Pub. No.: US 2002/0198756 A1
(43) Pub. Date: Dec. 26, 2002

(54) Resource capacity collaboration

(76) Inventors: Vinayak S. Ghaisas, Irving, TX (US); Sudarshan Seshadri, Irving, TX (US); Desikan Madhavanur, Richardson, TX (US); Ranjit N. Notani, Irving, TX (US)

Correspondence Address: Baker Botts L.L.P., 6th Floor, 2001 Ross Avenue, Dallas, TX, 75201-2980, US

(21) Appl. No.: 09/887,969

(22) Filed: Jun. 22, 2001

(51) Int. Cl. G06F 17/60

(52) U.S. Cl. 705/8

(57) ABSTRACT

A method for resource capacity collaboration includes accessing an assignment of an item used in producing a product for a customer to a first resource (108) of a factory (106) in a first production period, accessing a capacity value (136) representing a capacity of the first resource (108) to process one or more items in the first production period, accessing a demand value (138) representing a demand placed on the first resource (108) in the first production period by the assignment of the item (206) to the first resource (108), automatically generating a notification if the demand value (138) exceeds the capacity value (136), automatically communicating the notification to a user associated with the customer, and reassigning at least a portion of the demand placed on the first resource (108) in the first production period to at least one of a second resource (108) and a second production period.

### TECHNICAL FIELD OF THE INVENTION

This invention relates generally to the field of multi-enterprise collaboration, and more particularly to resource capacity collaboration.

### BACKGROUND OF THE INVENTION

A customer may obtain a manufactured product from a number of suppliers. Each supplier typically uses one or more factories to produce the product and each factory typically has one or more processing lines that produce the product. To obtain a quantity of the product, the customer typically places an order for the product with a supplier. The supplier typically responds by agreeing to provide all, some, or none of the requested quantity. If the supplier will provide at least some of the requested quantity, then the customer and the supplier typically agree on a delivery date for the product. In general, the customer lacks visibility into the supply chain, meaning that the customer is unaware of how production is proceeding. Instead, the customer typically knows only that the product order has been accepted and when to expect delivery.

### SUMMARY OF THE INVENTION

According to the present invention, problems and disadvantages associated with lack of customer visibility into its supply chain have been substantially reduced or eliminated.

In one aspect of the invention, a method for resource capacity collaboration includes accessing an assignment of an item used in producing a product for a customer to a first resource of a factory in a first production period, accessing a capacity value representing a capacity of the first resource to process one or more items in the first production period, accessing a demand value representing a demand placed on the first resource in the first production period by the assignment of the item to the first resource, automatically generating a notification if the demand value exceeds the capacity value, automatically communicating the notification to a user associated with the customer, and reassigning at least a portion of the demand placed on the first resource in the first production period to at least one of a second resource and a second production period. In a particular embodiment, the notification is also automatically communicated to at least one of a user associated with the factory and a user associated with a supplier.

Certain technical advantages may be provided according to various embodiments of the present invention. Particular embodiments of the invention may exhibit none, some, or all of the following advantages. For example, the present invention may provide a customer with visibility into at least a portion of its supply chain, allowing the customer to identify which resources its suppliers and their factories use to produce a product and to collaborate with the suppliers and factory operators to help ensure that its demand is timely satisfied. This visibility may be across one or more suppliers, one or more factories of a particular supplier, one or more processing lines of a particular factory, or one or more resources of a particular processing line, depending on the implementation. This may allow the customer, suppliers, and/or factory operators to more accurately identify capacity problems within the supply chain and actively participate in the resolution of those problems. For example, when excessive demand is placed on a resource within a processing line, the customer may be notified of the situation and may prompt the associated factory operator to reassign some or all of the demand to another resource within a different processing line within the factory, may prompt the associated supplier to reassign some or all of the demand to another resource within a different factory of the supplier, or may itself reassign some or all of the demand to a different supplier.

The increased supply chain visibility provided according to the present invention may also help the customer, suppliers, and/or factory operators ensure that resources are being used efficiently. For example, the customer may identify whether a resource is being used at full capacity or whether it may be used to produce additional amounts of a product. If the customer determines that a supplier has the capacity to produce additional amounts of a product, the customer may attempt to find one or more purchasers willing to buy the additional product, which may help to increase revenue for the customer. This may be particularly useful where the customer pays for some or all of the equipment used in the supplier's factory, such as an expensive mold or other fabrication equipment. This may allow the customer to ensure that the equipment paid for by the customer is being used to its fullest extent.

In addition, the increased supply chain visibility provided according to the present invention may help the customer save money. For example, without visibility into its supply chain, the customer may be unaware that demand for a product exceeds the capacity of a supplier and its factories to produce the product. The customer might not become aware of such a demand-capacity mismatch until relatively soon before the scheduled delivery date, such that the customer might then be forced to find another supplier with the capacity to produce the product “at the last moment,” perhaps paying a higher price for the product than would have been necessary had more lead time been available. With increased visibility into its supply chain, the customer may discover such demand-capacity mismatches sooner, such that the customer may actively participate in the resolution of the problem and thereby reduce or eliminate the likelihood that the customer will be forced to purchase the product from one or more other suppliers at a higher price. Also, with increased supply chain visibility, the customer, suppliers, and/or factory operators may engage in more efficient and accurate resource planning, which may help lower inventory levels and therefore save money.

Other technical advantages may be readily apparent to those skilled in the art from the figures, descriptions, and claims included herein.

### BRIEF DESCRIPTION OF THE DRAWINGS

To provide a more complete understanding of the present invention and features and advantages thereof, reference is made to the following description in conjunction with the accompanying drawings, in which:

FIG. 1 illustrates an example system for resource capacity collaboration;

FIG. 2 illustrates an example resource capacity tree;

FIG. 3 illustrates additional details of the resource capacity collaboration tree of FIG. 2;

FIG. 4 illustrates an example view of a supply chain;

FIGS. 5A and 5B illustrate another example view of a supply chain;

FIG. 6 illustrates yet another example view of a supply chain;

FIG. 7 illustrates an example item association wizard;

FIG. 8 illustrates an example method for resource capacity collaboration;

FIG. 9 illustrates an example method for providing resource capacity information to a user; and

FIG. 10 illustrates an example method for resource capacity collaboration.

### DESCRIPTION OF EXAMPLE EMBODIMENTS

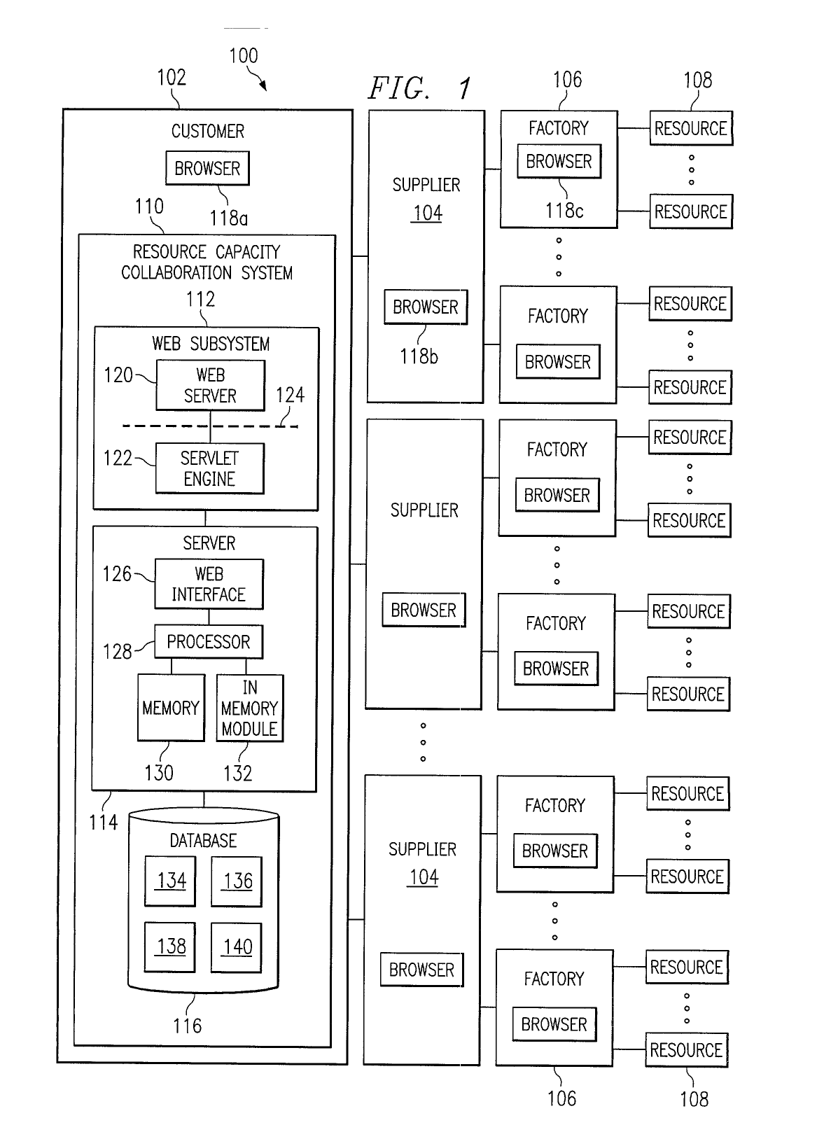

FIG. 1 illustrates an example system 100 for resource capacity collaboration. System 100 includes one or more customers 102, one or more suppliers 104, one or more factories 106, and one or more resources 108. Other embodiments of system 100 may be used without departing from the scope of the present invention.

Customer 102 may be any suitable entity that obtains at least one product from one or more suppliers 104. In this document, the term “product” refers to any manufactured, fabricated, assembled, or otherwise processed item. Supplier 104 may be any suitable entity that supplies at least one product to one or more customers 102. A supplier 104 may be completely owned by a customer 102, partially owned by one or more customers 102, or independent of customers 102. Each supplier 104 is associated with one or more factories 106, which produce the product supplied to customers 102 by supplier 104. Factory 106 may be any appropriate entity that manufactures, fabricates, assembles, or otherwise produces a product for one or more suppliers 104. Reference to a “factory” is meant to include one or more associated factory operators or other personnel where appropriate. A factory 106 may be completely owned by a supplier 104, partially owned by one or more suppliers 104, or independent of suppliers 104. Each factory 106 includes one or more resources 108. Resources 108 may represent processing lines, equipment associated with processing lines, labor associated with processing lines, or other suitable resources used to produce a product. A resource 108 may perform at least one operation on one or more items during production of a product. In this document, the term “item” refers to a raw material, part, component, assembly, intermediate product, or other suitable material used to produce a product. Customer 102, supplier 104, and factory 106 may communicate with one another using a network that includes one or more local area networks (LANs), metropolitan area networks (MANs), or wide area networks (WANs), a portion of the global computer network known as the Internet, or any other appropriate wired, wireless, or other links.

In one embodiment, customer 102 may place at least one order for a product with one or more selected suppliers 104. Each supplier 104 may instruct one or more factories 106 to produce the product for customer 102, possibly based on additional input from customer 102. To produce the product, one or more resources 108 are selected to process at least one item. The selection of resources 108 may be done by customer 102, supplier 104, and/or factory 106, depending on the relationships between these entities and the privileges afforded to each. A single resource 108 within a single factory 106 may be used to produce the product for customer 102, or multiple resources 108 in one or more factories 106 may be used in parallel and/or in series to produce the product for customer 102.

In the illustrated embodiment, a resource capacity collaboration system 110 provides visibility into the supply chain by, for example, allowing customer 102 to view resources 108 within one or more factories 106 of one or more suppliers 104 that are handling production of the product for the customer 102. System 110 may similarly allow supplier 104 to view resources 108 within one or more of its factories 106 that are handling production of a product for one or more customers 102. Factory 106 may view its resources 108 that are handling production of a product for one or more suppliers 104 and/or customers 102. By allowing customer 102, supplier 104, and/or factory 106 to view at least a portion of the supply chain, system 110 facilitates collaboration between the various entities involved in the supply chain. For example, the various entities may more accurately identify problems with the supply chain and actively participate in the resolution of those problems. As a particular example, if excessive demand is placed on a resource 108, customer 102, supplier 104, and/or factory 106 may reassign at least some of the demand to one or more other resources 108. This may also help customer 102, supplier 104, and/or factory 106 to ensure that resources 108 are being used efficiently, such as by identifying whether a resource 108 is being used at full capacity.

In the illustrated embodiment, collaboration system 110 includes a web subsystem 112, a resource capacity collaboration server 114 coupled to web subsystem 112, and a database 116 coupled to server 114. In this document, the term “couple” refers to any direct or indirect communication between two or more elements, whether or not those elements are in physical contact with one another. Web subsystem 112 facilitates communication between server 114 and one or more browsers 118 over one or more LANs, MANs, WANs, a portion of the Internet, or any other appropriate wired, wireless, or other links. Web subsystem 112 may include any hardware, software, firmware, or combination thereof suitable to facilitate communication between server 114 and browser 118. In the illustrated embodiment, web subsystem 112 includes a web server 120, a servlet engine 122 coupled to web server 120, and a firewall 124 separating web server 120 and servlet engine 122. Other embodiments of web subsystem 112 may be used without departing from the intended scope of the present invention.

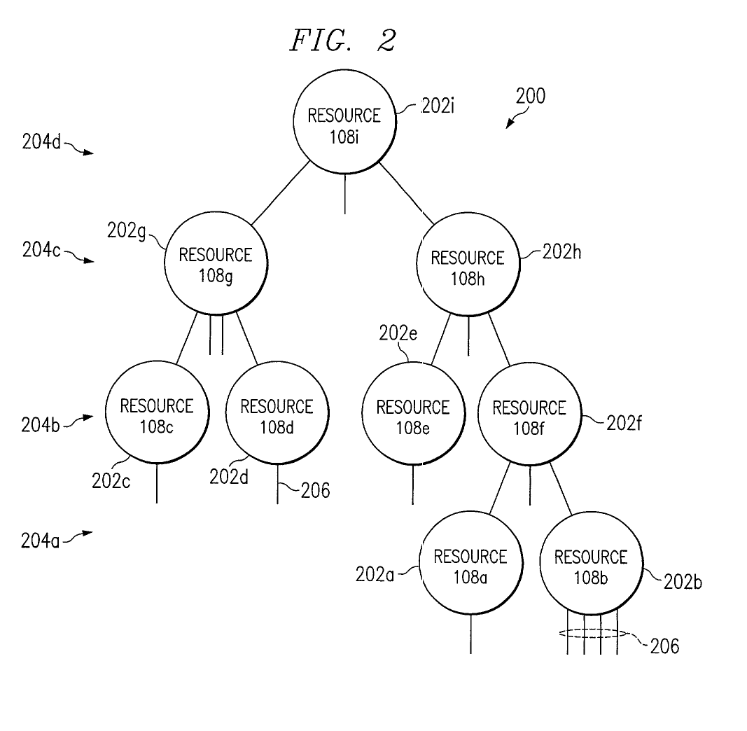

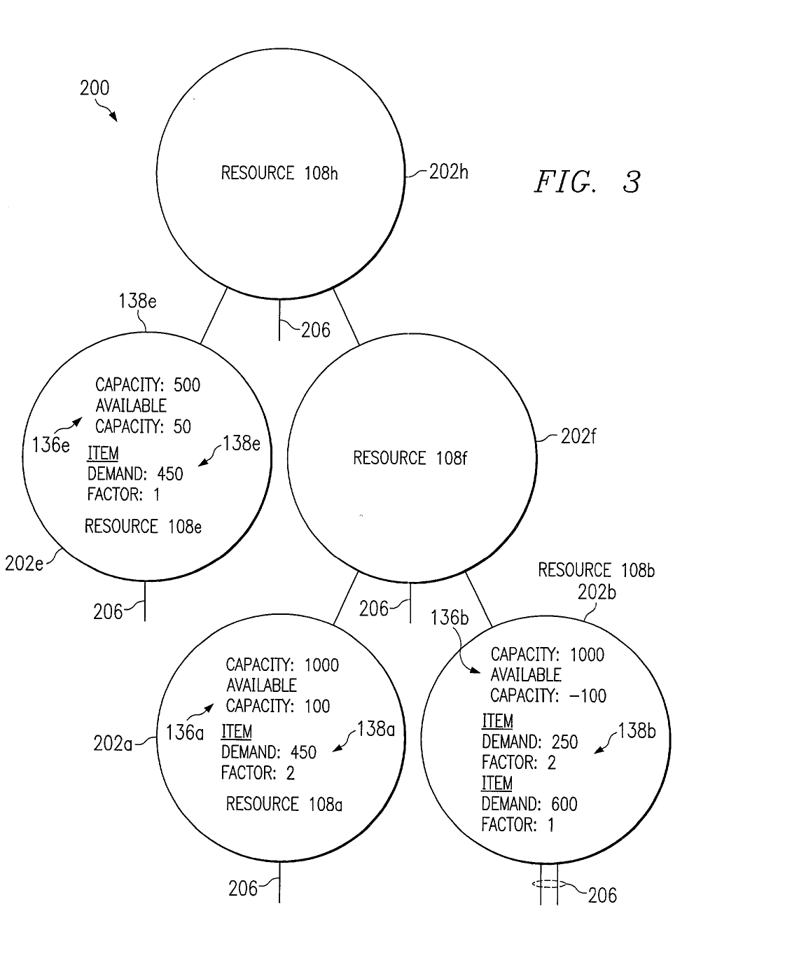

Web server 120 delivers web pages to browsers 118 of customer 102, one or more suppliers 104, and/or one or more factories 106. The web pages may, for example, contain information from database 116 and/or information generated by server 114 relating to resource capacity collaboration. As a particular example, a web page may contain a tree diagram illustrating the resources 108 being used to produce a product for customer 102, the capacity of each resource 108 nominally available to customer 102 (in the absence of any demand), and the demand that is currently placed on each resource 108 in connection with production of a product for customer 102, as described below with reference to FIGS. 2 and 3. Web server 120 may also receive information from browser 118. As a particular example, a customer 102, an associated supplier 104, and/or an operator of an associated factory 106 may reassign demand from a first resource 108 to a second resource 108 to produce the product for the customer 102. Web server 120 may include any hardware, software, firmware, or combination thereof suitable to facilitate communication with browsers 118. In one embodiment, web server 120 uses the Hypertext Transfer Protocol (HTTP) to deliver Hypertext Markup Language (HTML) documents to browser 118. Although web server 120 and web-based communications are primarily described, the present invention contemplates any suitable server using any suitable file format and communications protocol. For example, web server 120 could be replaced with a file server suitable for storing information that may be retrieved by users in system 100 and/or an e-mail server suitable for sending e-mail messages to users in system 100.

Servlet engine 122 stores and facilitates retrieval of one or more servlets. In one embodiment, servlets stored in servlet engine 122 represent programs designed to be executed from within web server 120. The servlets may, for example, represent programs that receive input from users using browsers 118 and generate displays for communication to browsers 118. The servlets may also communicate information to and receive information from server 114. In one embodiment, the servlets comprise JAVA code suitable to be executed by web server 120. Servlet engine 122 may include any hardware, software, firmware, or combination thereof suitable to store and facilitate retrieval of servlets.

Firewall 124 helps to prevent unauthorized access to servlet engine 122, server 114, and/or database 116. For example, firewall 124 helps to prevent unauthorized users using browsers 118 from accessing some or all of the information in database 116. In one embodiment, information entering or leaving web subsystem 112 passes through firewall 124, which examines the information and blocks information that does not meet specified security criteria. Firewall 124 may include any hardware, software, firmware, or combination thereof suitable to prevent unauthorized access to servlet engine 122, server 114, and/or database 116.

Server 114 processes information stored in database 116 and performs resource capacity collaboration operations on behalf of customer 102, one or more suppliers 104, and/or one or more factories 106. In the illustrated embodiment, server 114 includes a web interface 126, a processor 128, a memory 130, and an in-memory module 132. Other embodiments of capacity collaboration server 114 may be used without departing from the scope of the present invention.

Web interface 126 facilitates communication between server 114 and one or more web browsers 118 through web subsystem 112. Web interface 126 may include any hardware, software, firmware, or combination thereof suitable to facilitate communication between server 114 and web subsystem 112.

Processor 128 is coupled to web interface 126, memory 130, and in-memory module 132. Processor 128 executes instructions to perform the capacity collaboration functions of server 114. Processor 128 may be any suitable processor suitable to perform capacity collaboration functions. Although FIG. 1 illustrates a single processor 128 in server 114, multiple processors 128 may be used according to particular needs.

Memory 130 stores and facilitates retrieval of data used by processor 128 to perform the capacity collaboration functions of server 114. Memory 130 may include any hardware, software, firmware, or combination thereof suitable to store and facilitate retrieval of information. Although FIG. 1 illustrates memory 130 as residing within server 114, memory 130 may reside at any location accessible by processor 128.

In-memory module 132 receives and temporarily stores information to be placed in database 116. In-memory module 132 also receives and temporarily stores information retrieved from database 116 for use by processor 128. In-memory module 132 may include any hardware, software, firmware, or combination thereof suitable to buffer information to be stored in and/or retrieved from database 116.

Database 116 is coupled to server 114. Database 116 stores and facilitates retrieval of information used by server 114 to perform resource capacity collaboration operations in system 100, such as information related to the production of one or more products using resources 108. Database 116 may comprise any of a variety of data structures, arrangements, and/or compilations suitable to store and facilitate retrieval of information. Although FIG. 1 illustrates database 116 as residing within system 110, database 116 may reside in any suitable location or locations accessible by server 114. Database 116 may include any hardware, software, firmware, or combination thereof suitable to store and facilitate retrieval of information.

Database 116 may store and processor 128 may process any suitable information to perform resource capacity collaboration operations. The following examples are for illustration only. Any other and/or additional types of information may be used without departing from the scope of the present invention. Also, although the following description primarily describes server 114 receiving information from users associated with customer 102, one or more suppliers 104, and one or more factories 106 using browsers 118a, 118b, and 118c, respectively, other collection methods may be used. For example, a user could enter the data into server 114 using a workstation or other computing device coupled directly to server 114, server 114 could automatically generate some or all of this information, or some or all of this information could be supplied to server 114 by autonomous enterprise systems associated with customer 102, suppliers 104, and/or factories 106 independent of user input.

In one embodiment, database 116 stores assignment information 134 identifying which resources 108 are assigned to produce a product for a customer 102. For example, server 114 may allow customer 102, supplier 104, and/or factory 106 to assign and reassign one or more items used in producing the product to one or more resources 108. Customer 102, supplier 104, and/or factory 106 may assign items to resources 108 using any suitable method, such as through the use of an item association wizard that assists a user in assigning items to resources 108. Server 114 stores the assignment of items to resources 108 as assignment information 134 in database 116. Server 114 may also store information identifying a default resource 108 and/or an alternative resource 108 that may be assigned to process particular items. For example, two particular resources 108 may have the capability to process a particular item. Server 114 may identify one of the resources 108 as a default resource 108 to be used to process that particular item. Server 114 may also identify an alternative resource 108 to be used to process that particular item when the default resource 108 lacks the capacity to process the item. When customer 102, supplier 104, and/or factory 106 informs server 114 that the item will be processed, server 114 may automatically assign the item to the default resource 108 or the alternative resource 108. Other and/or additional types of default and alternative assignments may occur without departing from the scope of the present invention.

Database 116 may also store capacity information 136 identifying the capacity of one or more resources 108. The capacity of a resource 108 may, for example, represent the maximum quantity of an item that resource 108 can process in a specified time period, or the maximum number of time units during which that resource 108 can perform production operations in a specified time period. As a particular example, a resource 108 may be able to produce five hundred units of a product each week or process items during five hundred time units in a week. The period of time during which resource 108 may process an item may be referred to as a production period. Capacity information 136 may also represent the available capacity of a resource 108 during the production of a product for customer 102. For example, as the capacity of a resource 108 is reserved or committed to produce a product for a customer 102, the available capacity of the resource 108 decreases. Capacity information 136 may represent how much of the overall capacity is available for use on behalf of each customer 102 and/or supplier 104. Server 114 may make capacity information 136 available to customer 102, supplier 104, and/or factory 106, and the various entities may use the capacity information 136 in any suitable manner. For example, in one embodiment, the various entities may use capacity information 136 to identify whether a particular amount of a product can be produced and delivered to customer 102 by a particular date. The various entities could also use capacity information 136 to determine whether supplier 104 and factory 106 are providing the minimum and/or maximum capacity required to be given to customer 102 under a contract.

Database 116 may further store demand information 138 identifying the demand placed on one or more resources 108. The demand placed on a resource 108 may, for example, represent the quantity of an item that resource 108 is assigned to process in a specified time period, or the number of time units during which a resource 108 is expected to operate in a specified time period. As a particular example, a resource 108 may be assigned to produce four hundred fifty units of a product in a particular week or to process items during four hundred fifty time units during the week. In addition, demand information 138 may include a factoring value for a resource 108, which represents the actual capacity of the resource 108 consumed during the production of a product. For example, if a resource 108 normally produces ten units of a product per hour but a particularly intricate product requires twice as much processing, the factoring value indicates that resource 108 requires two units of capacity to produce one unit of the product. A user associated with customer 102, supplier 104, and/or factory 106 may specify the factoring value when inputting information identifying the demand placed on resource 108, or the factoring value may be specified automatically in connection with assignment of a particular resource 108 to produce a product for a particular customer 102.

In addition, database 116 may store access privilege information 140. Access privilege information 140 defines how much of the supply chain a customer 102, supplier 104, and/or factory 106 can view, and what types of information these entities may provide to server 114. For example, one entity may be allowed to view its entire supply chain while another entity may be allowed to view only a particular portion of its supply chain. In a particular embodiment, each supplier 104 may view the portion of the supply chain involving resources 108 of the factories 106 associated with that supplier 104 (but not factories 106 of other suppliers 104), and factory 106 may view its own resources 108 (but not resources 108 of other factories 106). Customer 102 may be given access privileges to view all resources 108 of all factories 106 that are assigned to produce a product for that customer 102, may be restricted to visibility at the factory level (aggregating all appropriate resources 108 within all appropriate factories 106), or may be restricted to visibility at the supplier level (aggregating all appropriate factories 106 of all appropriate suppliers 104). Access privileges 140 may be based on the particular user and/or based on whether the user is associated with customer 102, supplier 104, or factory 106. Other and/or additional access privileges may be used without departing from the scope of the present invention.

In a particular embodiment, access privileges 140 may be based, at least in part, on the relationships between the customer 102, suppliers 104, and/or factories 106. Different relationships may exist between these entities, and those relationships may determine what information can be viewed by each entity and how resources 108 are assigned to produce a product for customer 102. For example, in one embodiment, a supplier 104 may be completely owned by a customer 102, partially owned by one or more customers 102, or independent of customer 102. When a supplier 104 is completely owned by a customer 102, customer 102 may be authorized to view all resources 108 of all factories 106 associated with the supplier 104. Customer 102 may also be allowed to assign and reassign which resources 108 are used to produce a product for the customer 102. When a supplier 104 is partially owned by a customer 102, customer 102 may be authorized to view and make assignments with respect to certain resources 108 of certain factories 106 associated with supplier 104 which are used to produce a product for customer 102. As a particular example, a customer 102 may lease some of the resources 108 of a factory 106 associated with supplier 104 and be allowed to view those leased resources 108. Customer 102 may also be allowed to assign and reassign the leased resources 108. Supplier 104 may have additional resources 108, not leased by the customer 102, which customer 102 is not authorized to view or make assignments respecting but to which supplier 104 may transfer production of the customer's product if needed (perhaps without the customer's knowledge). When a supplier 104 is independent of customer 102, supplier 104 may independently determine which resources 108 will be used to produce a product for the customer 102, and customer 102 may have essentially no ability to assign or reassign such resources 108. Customer 102 may provide supplier 104 with information about the customer's demand, and the supplier 104 assigns and reassigns the demand to resources 108.

Server 114 may use the above and/or other information in any suitable combination to perform resource capacity collaboration operations. For example, in one embodiment, server 114 may make assignment information 134, capacity information 136, and/or demand information 138 available to customer 102, one or more suppliers 104, and/or one or more factories 106 based on access privileges 140. In a particular embodiment, server 114 provides the entities with one or more views of the supply chain. These views represent the status of customer 102, suppliers 104, factories 106, and/or resources 108, and each view may include some or all assignment information 134, capacity information 136, and/or demand information 138. The following example views are for illustration only. Other or additional views may be used without departing from the scope of the present invention. Also, although the following views are described as presenting information to a user associated with customer 102, the same or similar information may be provided to a user associated with a supplier 104 and/or a factory 106. In addition, the specific information provided to a user may vary depending on access privileges 140.

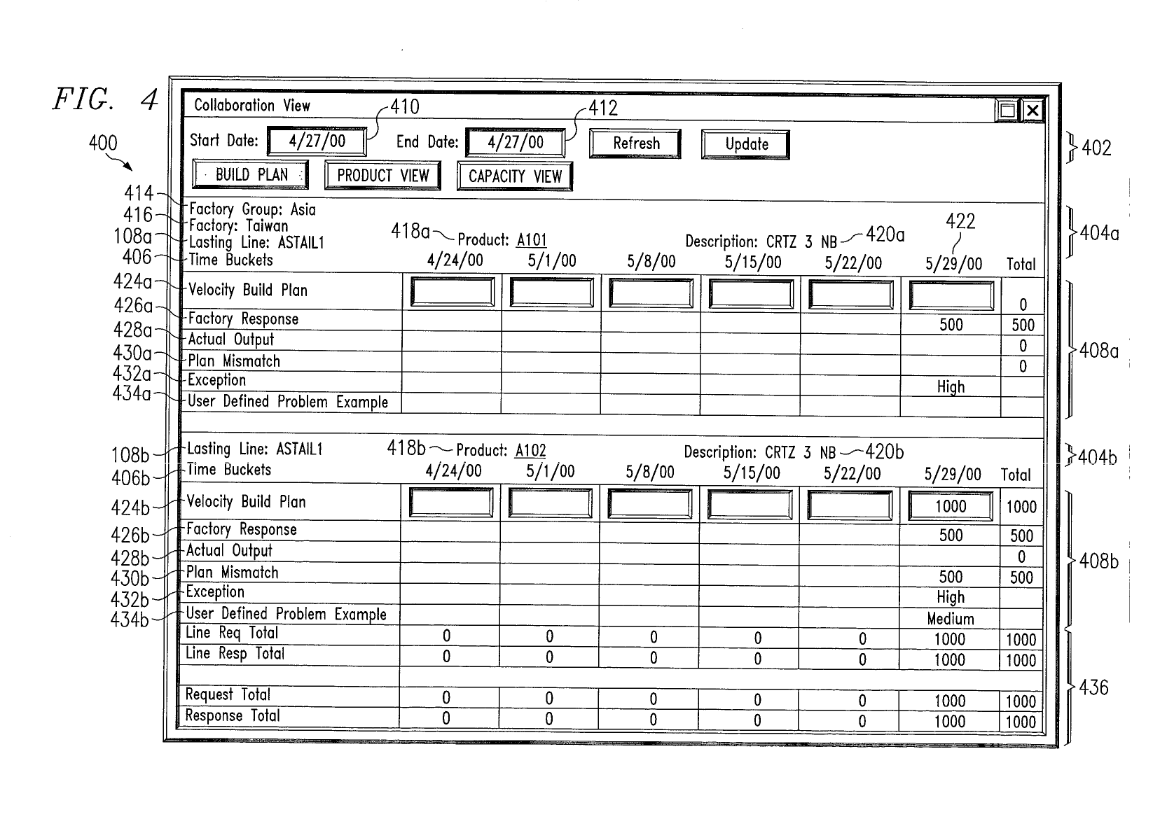

One view of the supply chain involves one resource 108 in one factory 106. In this view, server 114 may generate a display or otherwise communicate to a user information about a particular resource 108 in a particular factory 106. The information communicated to the user may, for example, include information about the items assigned to resource 108. For example, if the user is associated with a customer 102, server 114 may inform the user that resource 108 has been assigned to produce a particular product for the customer 102. The information communicated to the user may also include capacity information 136 and demand information 138, which identify the available capacity of the resource 108 and how much of that capacity has been reserved. One example of this view is illustrated in FIG. 4, which is described below.

Another view of the supply chain involves multiple resources 108 of one factory 106. In this view, server 114 may generate a display or otherwise communicate to a user information about each resource 108 in a particular factory 106 that is assigned or available for assignment to production on behalf of the entity with which the user is associated. The information communicated to the user may, for example, include information about the items assigned to the resources 108 in factory 106. As a particular example, if the user is associated with a customer 102, server 114 may inform the user how each resource 108 in factory 106 has been assigned to produce a product for the customer 102. The information communicated to the user may also include capacity information 136 and demand information 138 for each resource 108 involved in producing a product for customer 102. One example of this view is illustrated in FIG. 4, which is described below.

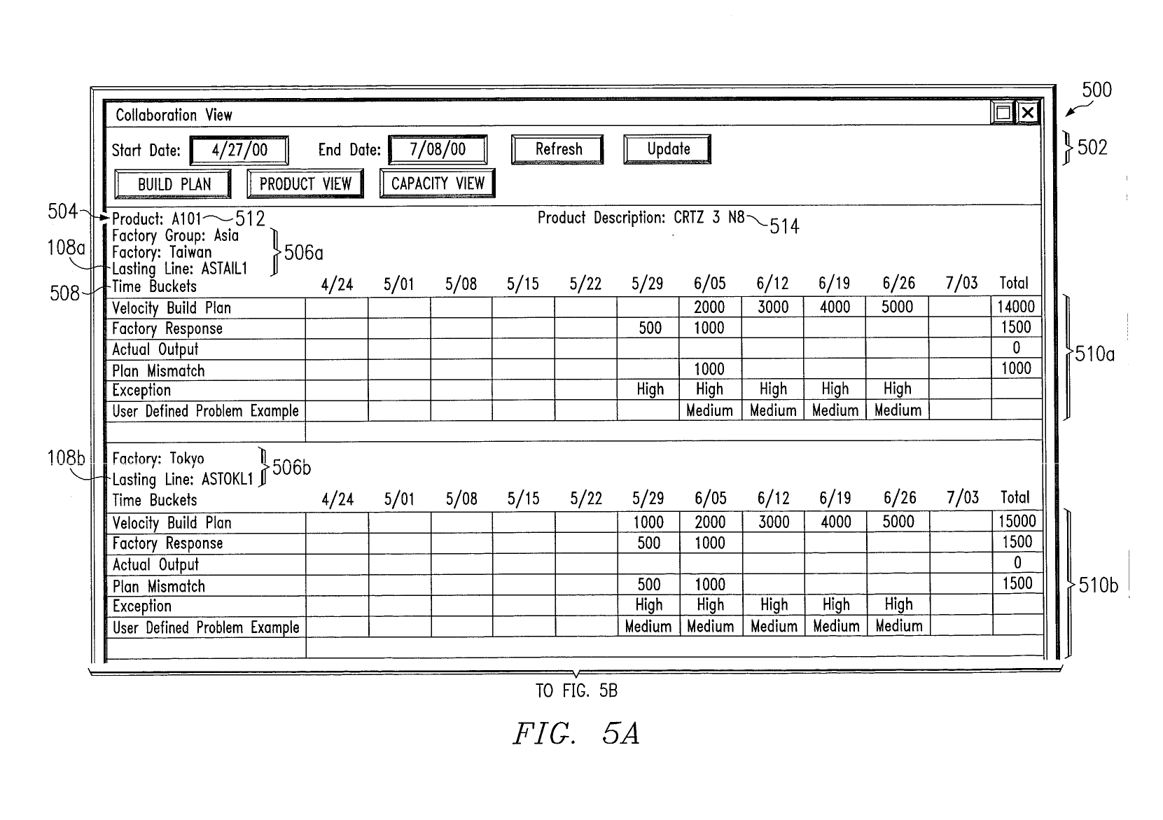

Yet another view of the supply chain involves a product. In this view, server 114 may generate a display or otherwise communicate to a user information about the suppliers 104, factories 106, and resources 108 involved in producing a particular product. For example, server 114 may inform customer 102 which resources 108 are assigned to process items and produce the product, how much capacity each of those resources 108 has, and how much demand has been placed on each of those resources 108. The resources 108 involved in the production of a product may involve resources 108 of a single factory, resources 108 of multiple factories 106 controlled by one supplier 104, or resources 108 of multiple factories 106 controlled by multiple suppliers 104. This view informs customer 102, supplier 104, and/or factory 106 how production of a product is being handled in the various factories 106 of various suppliers 104. One example of this view is illustrated in FIGS. 5A and 5B, which are described below.

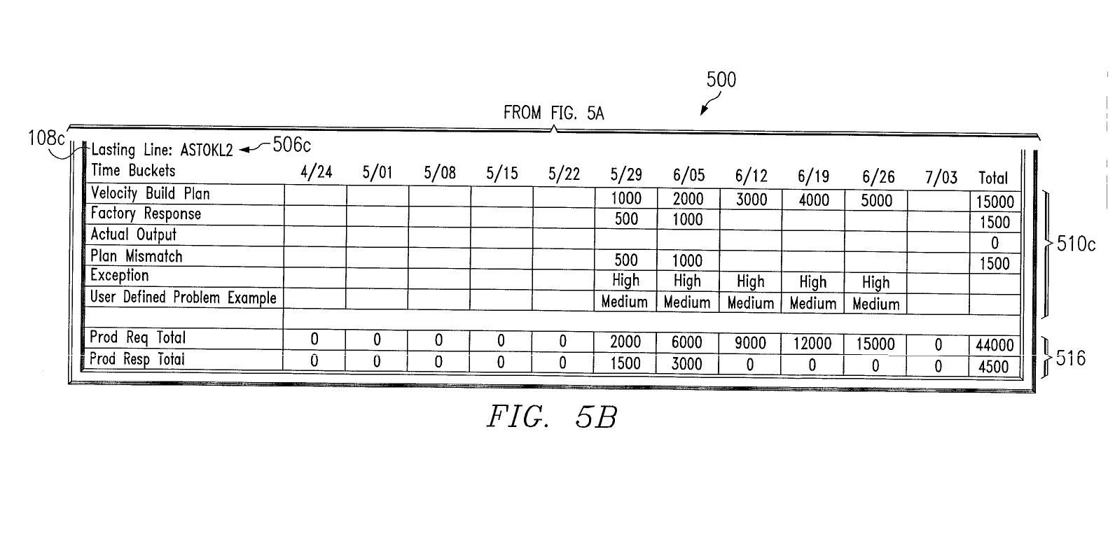

Still another view of the supply chain involves the capacity of a particular factory 106 or group of factories 106. In this view, server 114 may generate a display or otherwise communicate to a user information about the total or aggregate capacity of a particular factory 106 or group of factories 106. The group of factories 106 may, for example, be associated with a single supplier 104. In one embodiment, server 114 may estimate or allow customer 102 to estimate how much total capacity a factory 106 or group of factories 106 currently has. These estimates may be used, for example, by customer 102 in determining which factories 106 will be used in the future to produce a product. When the factory 106 or group of factories 106 informs server 114 of the actual capacity, server 114 may also inform customer 102 of the actual capacity. This information may allow a customer 102 to determine how accurate the customer's estimates were and allow the customer 102 to find alternative production sources if needed. One example of this view is illustrated in FIG. 6, which is described below.

To allow a user to view the supply chain in these various ways, server 114 may assist the user in selecting a particular group of factories 106, a particular factory 106, a particular resource 108, or a particular product. For example, if the user informs server 114 that the user wishes to view a group of factories 106, server 114 may present the user with a list of all appropriate groups of factories 106 (those involving production of a product for an entity with which the user is associated) and allow the user to select a group. Similarly, if the user wishes to view a particular factory, server 114 may present the user with a list of all appropriate factory groups, allow the user to select a group, present the user with a list of all appropriate factories 106 in that group, and allow the user to select a factory 106 in the list. When the user wishes to view a particular resource 108, server 114 may present the user with a list of appropriate factory groups and a list of appropriate factories 106 as described above, and then present the user with a list of appropriate resources 108 in the factory 106 selected by the user. When the user wishes to view a particular product, server 114 may allow the user to select an appropriate factory group or factory 106, display a list of all appropriate products produced by that group or factory 106, and allow the user to select a product. In addition, server 114 may store a default factory group and/or a default factory 106 for a user. These default values represent the factory group and/or factory 106 that the user has selected previously, and the user may not be required to select a factory group and/or factory 106 when selecting a view of the supply chain. Other methods of assisting the user may be used without departing from the scope of the present invention.

Using these and/or other views of the supply chain, customer 102, suppliers 104, and factories 106 may communicate and collaborate with one another to help supply a product to customer 102. For example, in one embodiment, the entities may share information about requests from customer 102 to identify the capacity of a supplier 104 to produce a product, and the commitments from supplier 104 and/or factory 106 to provide the requested capacity. The customer's request to identify capacity may form a requested production plan, and the commitments to capacity may form a committed production plan. The requested production plan represents the capacity that customer 102 has requested for the production of one or more products. The committed production plan represents the capacity that supplier 104 and/or factory 106 has committed to providing customer 102 for the production of the product. The entities may also collaborate and exchange information about orders from customer 102 that identify the customer's specific demand for the product, requests to reserve capacity to meet the customer's specific demand, and the commitments from supplier 104 and/or factory 106 to provide the capacity to meet the customer's specific demand. The entities may further exchange information identifying the excess capacity of other resources 108 that may be used to produce the product for customer 102. During production, server 114 may track the amount of the product that has been produced by factory 106. This allows customer 102 to identify how much of the product has actually been produced by factory 106, and customer 102 may determine whether the order will be completed on time.

As another example, customer 102, supplier 104, and/or factory 106 may assign a resource 108 to process at least one item used in producing a product for customer 102. Customer 102, supplier 104, and/or factory 106 may also specify the demand placed on the resource 108 by the assignment, such as by specifying the quantity of the item that will be processed by resource 108. In addition, customer 102, supplier 104, and/or factory 106 may change the demand placed on the resource 108, such as by increasing or decreasing the quantity of an item to be processed by the resource 108. Because the available capacity of a resource 108 depends, at least in part, on the demand placed on resource 108, a change in demand placed on resource 108 may also change the available capacity of resource 108. In one embodiment, server 114 updates the demand information 138 and the capacity information 136 in real-time, allowing a user to observe how a change in the demand placed on resource 108 affects the capacity of resource 108.

As yet another example, a user may view the resources 108 assigned to process items for customer 102. The user may, for example, view the demand placed on each resource 108 by the items, the capacity of each resource 108 that supplier 104 and/or factory 106 has committed to providing to meet the demand, and the actual capacity consumed by the demand placed on the resource 108. The actual capacity may be determined by taking into account any factoring information, the cycle time needed to process some quantity of the item, the yield produced during the cycle time, and/or any other suitable information. Customer 102, supplier 104, and/or factory 106 may also dynamically assign other resources 108 to meet a particular demand or to move demand from one resource 108 to another resource 108.

Further, a customer 102 may communicate and negotiate with a supplier 104 to receive a particular amount of capacity from a resource 108. The negotiation may occur through server 114, externally to server 114, or in any other suitable manner. Customer 102 may then request that resource 108 be used to process one or more items for customer 102, and supplier 104 and/or factory 106 may commit resource 108 to process the items. Customer 102 may view resource 108 to identify whether the total amount of capacity requested by customer 102 and the total amount of capacity committed to by supplier 104 meet the terns that were negotiated. Supplier 104 may additionally identify whether resource 103 has any additional capacity that has not been committed to the items.

In addition, customer 102, supplier 104, and/or factory 106 may use the views of the supply chain to identify and/or resolve problems with the supply chain. Server 114 may inform one or more of these entities of a problem with the supply chain by generating and communicating notification messages to customer 102, supplier 104, and/or factory 106. Server 114 may generate any suitable notification message, and server 114 may communicate the notification to a user in any suitable manner. For example, server 114 may generate an e-mail message alerting a user to a problem. Server 114 could also generate and store a message, and then wait for a user to access server 114 before displaying the message to the user on a web page or otherwise.

In one embodiment, when a problem is detected, server 114 generates an exception, and server 114 then allows a user to resolve the exception. For example, the user may move demand from one resource 108 to another resource 108, notify a supplier 104 of a contract violation, or take any other suitable corrective action to resolve the exception. In helping the user resolve an exception, the visibility provided by these or other views of the supply chain allows the user to view the problems in the supply chain as well as possible ways to resolve the exceptions.

Server 114 may generate and process any suitable exception. For example, one exception may identify a mismatch between the requested and committed production plans for an item at a particular resource 108. This may occur, for example, when a customer 102 has requested an amount of capacity or product, and supplier 104 and/or factory 106 has committed to a smaller amount of capacity or product. Another exception identifies when the capacity requested by customer 102 and/or the capacity committed to by supplier 104 and factory 106 falls outside the allowed contracted capacity under a capacity contract. A third exception identifies when excess capacity exists at one or more resources 108, and this exception may be resolved when the resource 108 having the excess capacity is assigned to process one or more items. A fourth exception may identify when an excessive amount of demand has been placed on a resource 108. This exception may be resolved when customer 102, supplier 104, and/or factory 106 reassigns at least a portion of the demand to other resources 108 and/or other production periods. A fifth exception may identify when a customer's estimation of the capacity of a factory 106 or group of factories 106 is incorrect by a predetermined amount. Other and/or additional exceptions may be used in system 100 without departing from the scope of the present invention.

Server 114 may perform one or more of these functions automatically. For example, when customer 102 orders a quantity of a product from supplier 104, server 114 may automatically select which factories 106 and resources 108 will be used to produce the product for customer 102 and how demand will be allocated across those factories 106 and resources 108. Server 114 could also monitor the demand placed on each resource 108 and automatically reassign demand to another resource 108 in the same or different factory 106 when the demand exceeds the capacity of the resource 108. Server 114 may reassign demand automatically without user input, in response to user input, or in any other suitable manner.

System 100 allows customers 102, suppliers 104, and factories 106 to gain visibility into the supply chain. For example, these entities may view all or a portion of the resources 108 that are producing a product for customer 102. System 100 also facilitates collaboration between these various entities. For example, a supplier 104 may perform planning operations across multiple Factories 106 associated with that supplier 104, and supplier 104 may move demand from resources 108 in one factory 106 to resources 108 in other factories 106. System 100 also provides visibility into the supply chain, such as by allowing a customer 102 to gain visibility into the resource planning and production plans of suppliers 104 for factories 106. This allows the entities to more accurately identify problems with the supply chain and actively participate in the resolution of those problems. This also allows the entities to perform more efficient and accurate planning operations, which may reduce inventory levels and save the entities money. In addition, system 100 also helps customer 102, supplier 104, and/or factory 106 to ensure that resources 108 are being used efficiently. One or more of the entities in the supply chain may identify when a resource 108 is not being used at full capacity, and the entities may collaborate and attempt to increase production of the product.

Although FIG. 1 illustrates an example embodiment of system 100, various changes may be made without departing from the scope of the present invention. For example, the components of server 114 may operate on one or more computers at one or more locations. Although system 110 is described primarily as being separate from suppliers 104 and factories 106, system 110 may share one or more computer or other appropriate resources with one or more suppliers 104 or factories 106 according to particular needs. System 110 could also operate separately from customer 102, operating within supplier 104, factory 106, or other location. Also, the functionality of server 114 may be implemented using any suitable computing device or devices, such as a workstation, a personal computer, or a laptop computer. Further, server 114 may allow a user to customize a view of the supply chain, such as by allowing the user to filter or otherwise limit the information displayed to the user. In addition, the capacity collaboration functionality of server 114 could be integrated into and/or communicate with legacy systems, databases, or planning engines such as a Factory Planner (FP) or a Supply Chain Planner (SCP). Other changes may be made to system 100 without departing from the scope of the present invention.

FIG. 2 illustrates an example resource capacity tree 200. Tree 200 may be useful, for example, in modeling the flow of product production across resources 108 within one or more factories 106 and in displaying such information to customer 102, supplier 104, and/or factory 106. The particular tree 200 shown in FIG. 2 is for illustration only. Any suitable tree 200 or other structure may be used to model and/or present resource information without departing from the scope of the present invention.

In the illustrated embodiment, tree 200 includes nodes 202. Each node 202 represents a resource 108 used to produce a product for customer 102. Nodes 202 may be arranged in tree 200 in one or more layers 204. Layers 204 may represent a hierarchical arrangement of resources 108 during production of a product. A resource 108 represented by a node 202 in one layer 204 may process items received from lower layers 204 in tree 200, along with any additional items provided to resource 108. For example, nodes 202a and 202b may represent resources 108a and 108b, respectively, that may receive and process raw materials. The resources 108 represented by nodes 202a and 202b may produce one or more intermediate products, which are then received and processed by the resource 108f represented by node 202f. Resource 108f may process the intermediate products produced by the resources 108a and 108b, along with any additional items required by resource 108f. Resource 108f then produces one or more additional intermediate products, which are received and processed by the resource 108h represented by node 202h. The process continues up to layer 204d, where the resource 108i represented by node 202i yields the end product for customer 102.

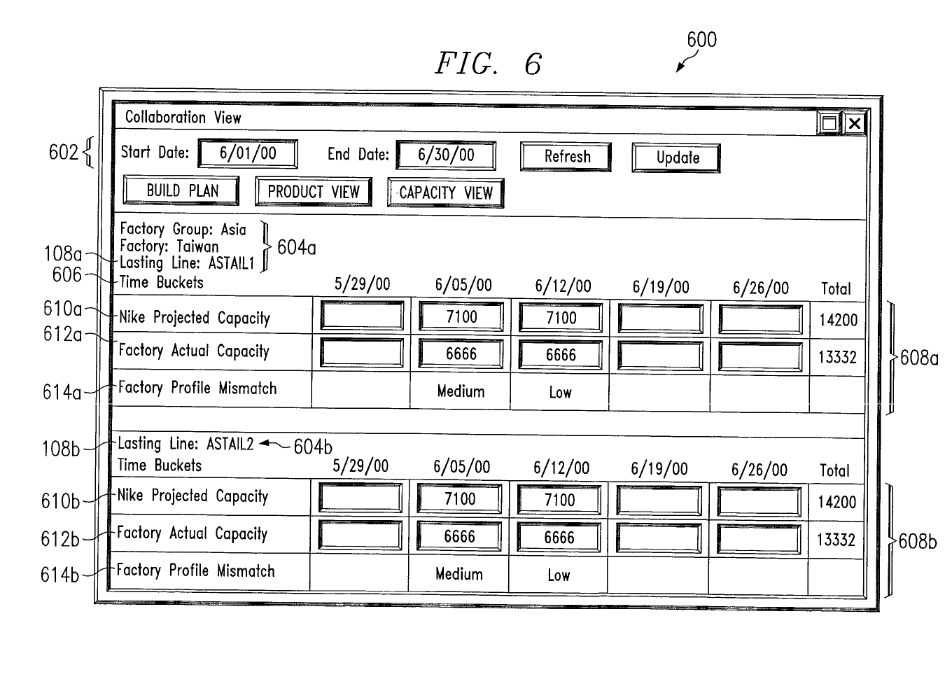

Each resource 108 represented by a node 202 may process one or more items 206 during production of the product. For example, a resource 108 may receive two or more items 206 representing raw materials that resource 108 will combine during the processing. As another example, resource 108 may receive two or more items 206 representing two different components to be polished, and resource 108 may process the items 206 in series. Items 206 may be assigned to resources 108 by a customer 102, supplier 104, and/or factory 106. Item 206 could be assigned to resource 108 using any suitable method, such as through the use of an item association wizard that assists a user in assigning an item 206. One example of an item association wizard is shown in FIG. 7, which is described below.

Server 114 may allow customer 102, supplier 104, and/or factory 106 to view all or a portion of tree 200. In one embodiment, a customer 102 may view that portion of tree 200 involving resources 108 that are producing a product for customer 102. A supplier 104 may view that portion of tree 200 involving resources 108 of factories 106 controlled or used by supplier 104. A factory 106 may view that portion of tree 200 involving resources 108 of that factory 106. This is one particular example of how access privileges may be assigned to customer 102, supplier 104, and factory 106. Other access privileges may be assigned to customer 102, supplier 104, and/or factory 106 in any suitable manner.

Tree 200 may be generated and shown to a customer 102, a supplier 104, and/or a factory 106 involved in the supply chair, such as through browsers 118. Tree 200 presents information about the supply chain in a readily interpretable form, allowing the various entities in the supply chain to view how the resources 108 in the supply chain are being used to produce a product. This may allow, for example, one or more of the entities to identify problems in the supply chain. This may also allow one or more of the entities to identify whether capacity exists in the supply chain to produce a product, and whether additional capacity exists to produce additional amounts of a product.

In the illustrated embodiment, tree 200 may represent the entire display presented to a user. In another embodiment, tree 200 may represent a portion of the display presented to the user. In this embodiment, any other information may be presented to the user in the remaining portion of the display. For example, in a particular embodiment, tree 200 is presented to a user in one frame of a display. When the user selects one of the nodes 202, information about node 202 may be presented to the user in another frame of the display. For example, when a user selects a node 202, capacity information 136, demand information 138, and/or any other suitable information may be presented to the user.

FIG. 3 illustrates additional details of tree 200 of FIG. 2. In the illustrated embodiment, each node 202 has associated capacity information 136 and demand information 138. The information and values shown in FIG. 3 are for illustration only. Other suitable information and/or values may be used without departing from the scope of the present invention.

Server 114 may retrieve capacity information 136 from database 116, memory 130, and/or in-memory module 132. In the illustrated embodiment, capacity information 136 includes the overall capacity of resource 108 and the available capacity of resource 108 during the production of at least one product for one or more customers 102. Capacity information 136 may be expressed in terms of a number of items 206 that can be processed, a number of time units in a given time period, or any other suitable value or values representing the capacity of resource 108. Additional and/or other information related to the capacity of resource 108 may be used without departing from the scope of the present invention.

In one embodiment, server 114 may modify the capacity information 136 presented to a customer 102, depending on the identity of customer 102. For example, a supplier 104 may supply products to multiple customers 102, and each customer 102 may only be allowed to consume a portion of the capacity of a resource 108. As a particular example, if supplier 104 supplies two customers 102, one customer 102a may only be allowed to consume up to sixty percent of the capacity of the resources 108 of supplier 104. The other customer 102b may only be allowed to consume up to forty percent of the capacity of the resources 108 of supplier 104. In this embodiment, server 114 may display to each customer 102 the relative capacity 136 that customer 102 may consume. Continuing with the example, while resource 108a has a total capacity 136 of one thousand units, customer 102a may only be allowed to consume up to six hundred units of that capacity, and customer 102b may only be allowed to consume up to four hundred units of capacity. Server 114 may inform a user associated with customer 102a that resource 108 has a total capacity of six hundred units, and server 114 may inform a user associated with customer 102b that resource 108 has a total capacity of four hundred units. In this way, one customer 102a may be unable to determine how much capacity another customer 102b is consuming. This helps to increase the security of system 110 by reducing the likelihood that customers 102 will discover information about other customers 102.

Server 114 may also retrieve demand information 138 from database 116, memory 130, and/or in-memory module 132. In the illustrated embodiment, demand information 138 includes the demand placed on a resource 108 by each item 206 assigned to that resource 108. Demand information 138 may, for example, be expressed in terms of the number of items 206 currently assigned to be processed by resource 108, the number of time units that it will take for resource 108 to process the items 206 currently assigned to resource 108, or any other suitable value or values representing the demand placed on resource 108. Demand information 138 may involve a single item 206 for a customer 102 or multiple customers 102, as shown for node 202a and 202e, or multiple items 206 for a customer 102 or multiple customers 102, as shown for node 202b. Additional and/or other information related to the demand placed on resource 108 may be used without departing from the scope of the present invention.

In the illustrated embodiment, demand information 138 also includes a factoring value. The factoring value represents the actual capacity of resource 108 consumed by an item 206 during the production of a product. For example, as shown in FIG. 3, resource 108e represented by node 202e has the capacity to process five hundred units in a given period. The demand placed on resource 108e is for four hundred fifty items with a factoring value of one, meaning that resource 108e consumes four hundred fifty units of capacity to process the demand. As a result, the capacity of resource 108e exceeds the demand placed on resource 108e, and resource 108e can meet the demand in this period of time. Similarly, resource 108a represented by node 202a has the capacity to process one thousand units in a given period. The demand placed on resource 108a is for four hundred fifty items with a factoring value of two, meaning that resource 108a consumes nine hundred units of capacity, (450 items* 2 capacity units per item), to process the demand. As a result, the capacity of resource 108a also exceeds the demand placed on resource 108a, and resource 108a can meet the demand in this period of time. On the other hand, resource 108b represented by node 202b has the capacity to process up to one thousand units in a given time period. The demand placed on resource 108b is for two hundred fifty items with a factoring value of two, or five hundred units of capacity, plus six hundred additional items with a factoring value of one, or six hundred units of capacity. This means that resource 108b would need to consume one thousand one hundred units of capacity to process these items and meet the demand placed on resource 108b, which exceeds the capacity of resource 108b.

The factoring value for each item 206 may affect the available capacity of resources 108 in higher layers 204 of tree 200. For example, resource 108a requires nine hundred units of capacity to process four hundred fifty units of an item 206 because item 206 has a factoring value of two. Similarly, resource 108f will receive and process the four hundred fifty units of item 206 after resource 108a processes the item 206, and resource 108f may require nine hundred units of capacity because of the factoring value. As a result, server 114 may determine that the demand placed on resource 108f due to the factoring value is nine hundred units of capacity. Server 114 computes the demand 138 for resource 108f by taking into account the factoring value of an item 206 in a lower level 204 of tree 200. In this manner, when a resource 108 is assigned or reassigned to process a demand 138, any factoring value associated with demand 138 may be propagated up through other resources 108 in tree 200.

When the demand placed on a resource 108 exceeds the capacity of resource 108, resource 108 cannot meet the demand during this period of time. System 100 may generate a notification for customer 102, supplier 104, and/or factory 106, informing one or more of these entities of this problem. For example, system 100 may generate and communicate an e-mail message to customer 102, supplier 104, and/or factory 106, alerting these entities of the capacity-demand mismatch. System 100 may also automatically reassign or allow customer 102, supplier 104, and/or factory 106 to reassign a portion of the demand from one resource 108b to another resource 108 or from one time period to another time period, reducing the demand placed on resource 108b.

In one embodiment, different entities may be allowed to reassign demand in different ways. For example, a customer 102 may be allowed to reassign demand across different suppliers 104, supplier 104 may only be allowed to reassign demand across its own factories 106, and factory 106 may only be allowed to reassign demand across its own resources 108. System 100 may further recommend to customer 102, supplier 104, and/or factory 106 how to reassign demand so that demand on resource 108b no longer exceeds the capacity of resource 108b.

In another embodiment, supplier 104 may be allowed to prioritize competing demands from multiple customers 102. As explained above, each customer 102 may only be allowed to consume a portion of the capacity 138 of a resource 108. For example, resource 108e may have a total capacity of one thousand units, one customer 102a may be allowed to consume six hundred units of capacity, and another customer 102b may be allowed to consume four hundred units of capacity. However, one customer 102a may need extra capacity during a particular period of time, and the other customer 102b may not be using all of its capacity during that time. For example, one customer 102a may need seven hundred units of capacity during a production period, and the other customer 102b may only have requested three hundred units of capacity during that period. Customer 102a may be unable to reserve the additional one hundred units of capacity because the access privileges 140 in server 114 prevents customer 102a from identifying the capacity being reserved by customer 102b. However, customer 102a may request additional capacity, and supplier 104 may determine whether to allow customer 102a to reserve the extra capacity.

Although FIG. 3 illustrates nodes 202a, 202b, and 202e as including capacity information 136 and demand information 138, other nodes in tree 200 may have analogous associated information. Also, other or additional information may be included in one or more nodes 200 without departing from the scope of the present invention. In addition, the information contained within nodes 202 could also be presented to a user in a separate part of a display, such as in a separate frame in the display.

FIG. 4 illustrates an example view 400 of a supply chain. In particular, view 400 illustrates a view of one or more resources 108 of a particular factory 106. View 400 could include information about a single resource 108, or view may include information about multiple resources 108 in the factory 106. In the illustrated embodiment, view 400 includes a time period section 402, a resource identifier section 404, a time bucket section 406, and a resource information section 408. Other and/or additional information may be used in view 400 without departing from the scope of the present invention. Also, the following are examples of information that may be included in the different sections of view 400. Other information and/or arrangements of information may be used without departing from the scope of the present invention.

Time period section 402 identifies the time period covered by view 400. Time period section 402 may include any suitable information identifying a time period during which a resource 108 may be in use. For example, time period section 402 may include a start date 410 and/or an end date 412, which identify the period of time when at least one resource 108 may be processing one or more items 206. The start date 410 and end date 412 may be supplied and changed by the user, allowing the user to view different production periods.

Resource identifier section 404 identifies the one or more resources 108 that are being viewed by the user. In FIG. 4, a resource 108 may be referred to as a “line.” Resource identifier section 404 may include any suitable information identifying one or more resources 108. In the illustrated embodiment, a first resource 108a is identified by resource identifier section 404a, and a second resource 108b is identified by resource identifier section 404b. Resource identifier section 404a includes factory group information 414 identifying the factory group of resource 108a, factory information 416 identifying the factory 106 of resource 108a, a product code 418a identifying the product being produced by resource 108a, and a description 420a of the product being produced by resource 108a. Resource identifier section 404b includes a product code 418b and description 420b of the product being produced by resource 108b. Resource 108b may be within the same factory group and factory 106 as resource 108a, so resource identification section 404b may but need not include a factory group identifier 414 and a factory identifier 416.

Time bucket section 406 identifies one or more windows or “buckets” of time 422. Each bucket 406 may identify a production period during which resource 108 processes one or more items 206. In the illustrated embodiment, time bucket section 406 includes six time buckets 422, each covering a week of time. A time bucket 422 may be shaded or otherwise indicated when the time bucket 422 begins before start date 410. While FIG. 4 illustrates a time bucket 422 for each of six weeks, other suitable lengths of time, such as days in a week or work shifts in a day, and number of buckets may be used.

Resource information section 408 provides information about a resource 108. In the illustrated embodiment, resource information section 408 includes a build plan entry 424, a factory response entry 426, an actual output entry 428, a plan mismatch entry 430, an exception entry 432, and a user defined problem entry 434. Build plan entry 424 allows a user, such as a user associated with customer 102, to order a quantity of product 418, which will be produced by resource 108. Supplier 104 and/or factory 106 may respond to the order by supplying a response, which is shown in factory response entry 426. The factory response 426 identifies the quantity of product that the supplier 104 and/or factory 106 is willing to produce for customer 102. Actual output entry 428 displays the quantity of product actually produced by resource 108 for a particular order.

If a customer 102 orders a quantity of product through build plan entry 424 and the response 426 of supplier 104 and/or factory 106 is for less than the requested quantity, plan mismatch entry 430 identifies the extent of the mismatch. Also, some mismatches may be more critical in nature than others, as defined by the user, and exception entry 432 identifies the criticality of the mismatch. In addition, different types of notifications may correspond to different exceptions, and user defined problem entry 434 identifies the type of notification to be communicated to the user.

In addition, view 400 may include one or more totals sections 436, which may identify the total quantity of products 418 ordered by the user and the total quantity to which the supplier 104 and/or factory 106 has committed. The total quantity of ordered products 418 and the total quantity committed to may be broken down by resource 108 and/or summed across all resources 10B.

As shown in FIG. 4, the user, such as a customer 102, has ordered one thousand units of product 418b for the “May 29, 2000” time bucket 422 in build plan entry 424b. Supplier 104 and/or factory 106 has responded by committing to five hundred units of product 418b, which is shown in factory response entry 426b. This creates a mismatch of five hundred units, shown in plan mismatch entry 430b. The mismatch creates an exception 432b having a criticality of “High,” and a “Medium” notification 434b is sent to the user.

Although FIG. 4 illustrates one example of a view 400, various changes may be made to view 400 without departing from the scope of the present invention. For example, while FIG. 4 illustrates view 400 as including information about a single resource 108, view 400 could include information about multiple resources 108. Also, other views may be used to provide this information to a user. In addition, any suitable type of exception 432 and/or user defined problem 434 may be used in system 100.

FIGS. 5A and 5B illustrate another example view 500 of a supply chain. In particular, view 500 illustrates a view of the factories 106 and resources 108 involved in producing a product for a customer 102. In the illustrated embodiment, view 500 includes a time period section 502, a product identifier section 504, a resource identifier section 506, a time bucket section 508, and a resource information section 510. Other and/or additional information may be used in view 500 without departing from the scope of the present invention. Also, the following are examples of information that may be included in the different sections of view 500. Other information and/or arrangements of information may be used without departing from the scope of the present invention.

Time period section 502 identifies the time period covered by view 500. Product identifier section 502 identifies the product that the user has requested. Product identifier section 502 may include a product code 512 identifying the product and a description 514 of the product being produced by resource 108a. Resource identifier section 506 identifies the one or more resources 108 that are being used to produce product 512. Resource identifier section 506 may include any suitable information identifying one or more resources 108, such as a factory group name and factory name. Time bucket section 508 identifies one or more production periods. Resource information section 510 provides information about the resources 108 that are being used to produce product 512. A totals section 516 includes the total amount of product requested by customer 102 and the total amount committed to by supplier 104 and/or factories 106.

Although FIGS. 5A and 5B illustrates one example of a view 500, various changes may be made to view 500 without departing from the scope of the present invention. For example, other views may be used to provide this information to a user.

FIG. 6 illustrates yet another example view 600 of a supply chain. In particular, view 600 illustrates a view of the capacity of a factory 106. In the illustrated embodiment, view 600 includes a time period section 602, a resource identifier section 604, a time bucket section 606, and a capacity information section 608. Other and/or additional information may be used in view 600 without departing from the scope of the present invention. Also, the following are examples of information that may be included in the different sections of view 600. Other information and/or arrangements of information may be used without departing from the scope of the present invention.

Time period section 602 identifies the time period covered by view 600. Resource identifier section 604 identifies the one or more resources 108 within a factory 106, such as by factory group name and factory name. Time bucket section 606 identifies one or more production periods. Capacity information section 608 identifies capacity information about resources 108 in the selected factory 106. In the illustrated embodiment, the capacity information section 608 includes a customer projected capacity 610, an actual capacity 612, and a capacity mismatch 614. Projected capacity 610 identifies the projection or estimation by customer 102 of the total or available capacity of a resource 108. Actual capacity 612 identifies the actual available capacity of resource 108. When the customer's estimation of the capacity is different than the actual capacity, a capacity mismatch may occur, and server 114 generates a notification message. Because the extent of a capacity mismatch may vary in criticality, entry 614 identifies the type of notification.

Although FIG. 6 illustrates one example of a view 600, various changes may be made to view 600 without departing from the scope of the present invention. For example, view 600 could include information about a group of factories 106, rather than information about a single factory 106. Also, other views may be used to provide this information to the user.

FIG. 7 illustrates an example item association wizard 700. Item association wizard 700 may be useful, for example, in initially assigning demand to a resource 108a or in reassigning demand from a source resource 108a to a destination resource 108b when the demand placed on resource 108a exceeds the capacity of resource 108a. In a particular embodiment, each item 206 that is assigned to a resource 108 may be reassigned using item association wizard 700. In the illustrated embodiment, item association wizard 700 includes a factory group identifier 702, an association type identifier 704, a source resource identifier 706, and a destination resource identifier 708. Other and/or additional information may be used in item association wizard 700 without departing from the scope of the present invention.

The source and destination resources 108 may be associated with a group of factories 106, and factory group identifier 702 identifies the factory group that is associated with the resources 108. The association type identifier 704 identifies whether the item 206 being reassigned is being reassigned for one or multiple production periods.

Source resource identifier 706 contains information identifying the source resource 108 from which an item 206 is being removed. In the illustrated embodiment, source resource identifier 706 includes a factory identifier 710 identifying the factory 106 in which the resource 108 operates, and a resource identifier 712 identifying the source resource 108. Source resource identifier 706 also includes an item identification 714 identifying the item 206 being removed from source resource 108. Source resource identifier 706 may further include a start bucket entry 716 and an end bucket entry 718. As described above, an item 206 may be reassigned from one resource 108 to another resource 108 for one or multiple production periods. If association type identifier 704 indicates that the reassignment involves one production period, the user may specify the time bucket using start bucket entry 716. If multiple production periods are involved, the user may specify the time buckets using start bucket entry 716 and end bucket entry 718.

Destination resource identifier 708 contains information identifying the destination resource 108 to which an item 206 is being assigned. In the illustrated embodiment, destination resource identifier 708 includes a factory identifier 720 identifying the factory 106 in which the destination resource 108 operates, and a resource identifier 722 identifying the destination resource 108. Destination resource identifier 708 may also include a time bucket identifier 724 identifying the production period to which the item 206 is being assigned, and the quantity 726 of item 206 that will be processed in that production period.

In one embodiment, an item 206 may be associated with an initial production time identifier. The initial production time identifier indicates the earliest production period in which item 206 may be produced. For example, the initial production time identifier may indicate that an item 206 may be produced during or after the fifth time bucket. When a user attempts to move an item 206 to another resource 108 and/or to another time bucket, item association wizard 700 may examine the time bucket identifier 724 entered by the user. Item association wizard 700 may compare time bucket identifier 724 to the initial production time identifier associated with item 206. If the time bucket identifier 724 occurs before the initial production time identifier, item association wizard 700 may not allow the user to move item 206. In this case, the initial production time identifier of item 206 indicates that the item 206 may not be produced during the time bucket identifier 724 requested by the user.

Although FIG. 7 illustrates one example of an item association wizard, various changes may be made to wizard 700 without departing from the scope of the present invention. For example, wizard 700 may determine whether the user is reassigning demand from one or multiple production periods based on the information provided in entries 716 and 718, without asking the user for association type identifier 704. Also, other methods of reassigning an item 206 from one resource 108 to other resources 108 may be used without departing from the scope of the present invention.

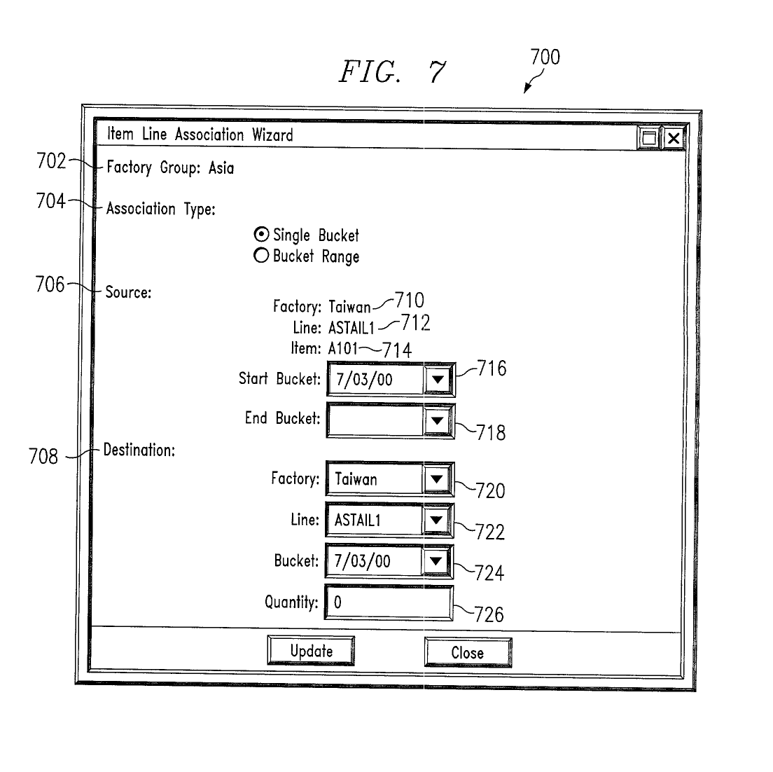

FIG. 8 illustrates an example method 800 for resource capacity collaboration. Server 114 stores an assignment of a resource 108 to an item 206 associated with a customer 102 at step 802. This may include, for example, server 114 storing the assignment as assignment information 134 in database 116. The assignment indicates that the resource 108 of a factory 106 will process an item 206 for customer 102. Server 114 may receive the assignment from a user using a browser 118, or server 114 may automatically assign the resource 108 to the customer 102. Server 114 stores capacity information about resource 108 at step 804. This may include, for example, server 114 storing the information as capacity information 136 in database 116. The capacity information 136 may represent the total and/or available capacity of resource 108 for processing one or more items 206. Server 114 further stores demand information about the assignment of resource 108 to item 206 at step 806. This may include, for example, server 114 storing the information as demand information 138 in database 116. The demand information 138 may represent the amount of capacity of resource 108 that will be consumed during the processing of item 206. The demand information 138 may or may not include factoring information.

Server 114 makes this information available to factory 106, supplier 104, and customer 102 at step 808. This may include, for example, server 114 allowing a user associated with factory 106, supplier 104, or customer 102 to access database 116 and view one or more aspects of the supply chain. This may also include server 114 ensuring that any access privileges 140 are enforced.

Server 114 determines whether the demand placed on resource 108 exceeds the capacity of resource 108 at step 810. This may include, for example, server 114 considering any factoring values associated with demand information 138. If the demand does not exceed the capacity of resource 108, method 800 ends. Otherwise, server 114 generates a notification message at step 812. The notification message may include a warning message identifying the resource 108, the capacity of resource 108, the demand currently placed on resource 108, and the amount that the demand exceeds the capacity. Server 114 communicates the message to a user associated with customer 102 at step 812. Server 114 may also communicate the message to users associated with supplier 104 and/or factory 106. This may include, for example, communicating the notification message to the user by e-mail or by web page when the user logs on to server 114.

Server 114 reassigns at least a portion of the demand to other resources 108 and/or to other production periods at step 814. Server 114 may reassign the demand automatically without user input. Server 114 may also receive instructions from one or more users associated with customer 102, supplier 104, and/or factory 106 instructing server 114 to move the demand to other resources 108 or production periods. By allowing a user associated with customer 102 to participate in the resolution of the demand-capacity mismatch, server 114 facilitates collaboration among the entities of the supply chain. Customer 102, supplier 104, and factory 106 may have the opportunity to reassign demand to other resources 108 and/or production periods when demand-capacity mismatches occur. Also, because each entity may have differing views of the supply chain, the entities may be able to reassign demand in different ways. For example, supplier 104 and factory 106 may view all resources 108 in that factory 106, while customer 102 may be restricted to viewing only specific resources 108. Similarly, supplier 104 may be able to view resources 108 in one factory 106 that another factory 106 cannot view, and supplier 104 may be able to view the total capacity of a resource 108 while a customer 102 can only view a portion of that capacity. Further, customer 102 may be able to view resources 108 across multiple suppliers 104. As a result, each entity may be able to reassign demand in different ways. By giving these entities the opportunity to resolve demand-capacity mismatches, server 114 facilitates collaboration in the supply chain.

While FIG. 8 illustrates one example of a method 800 for resource capacity collaboration, various changes may be made to method 800 without departing from the scope of the present invention. For example, FIG. 8 illustrates server 114 determining whether the demand placed on a resource 108 exceeds the capacity of resource 108. Server 114 may also identify other problems in the supply chain, such as when a mismatch between requested and committed capacity occurs, when the capacity requested by customer 102 and/or the capacity committed to by supplier 104 and factory 106 falls outside the allowed capacity under a capacity contract, and when excess capacity exists at one or more resources 108.

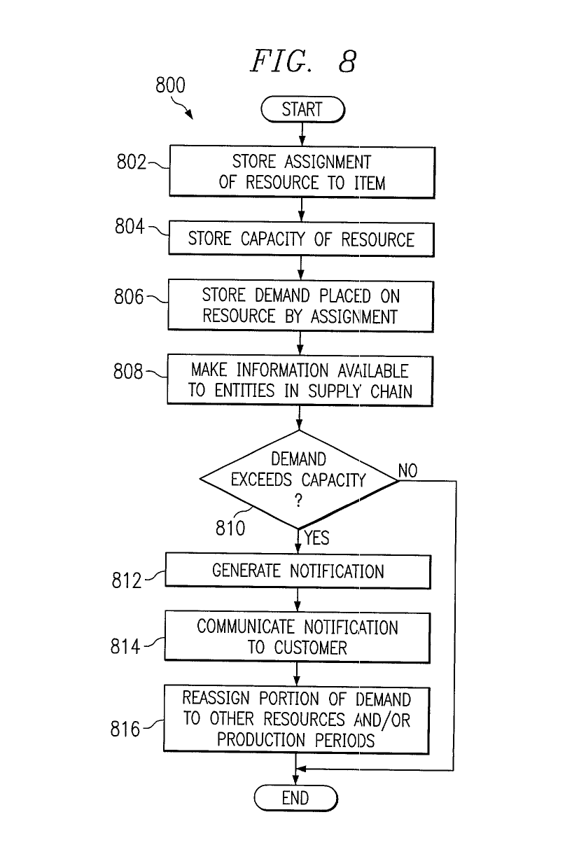

FIG. 9 illustrates an example method 900 for providing resource capacity collaboration information to a user. Server 114 receives a request to view the supply chain at step 902. This may include, for example, a user associated with customer 102, supplier 104, and/or factory 106 using browser 118 to initiate the request. The request may identify the specific view of the supply chain that the user wishes to see. Server 114 identifies the user making the request at step 904. This may include, for example, server 114 identifying the user based on a user name, a network address of the user's computing device operating browser 118, or in any other suitable manner. Server 114 retrieves the access privileges of the user at step 906. This may include, for example, server 114 retrieving the user's access privileges from access privileges information 140 in database 116.

Server 114 identifies the information that may be displayed to the user at step 908. For example, if the user is associated with customer 102 and wishes to view the resources 108 producing a product for customer 102, server 114 may identify which resources 108 are assigned to process items 206 that are associated with customer 102. A supplier 104 may be allowed to view any resource 108 of a factory 106 owned or otherwise controlled by supplier 104, or any resource 108 assigned to an item 206 associated with supplier 104. A factory 106 may view its own resources 108. Other access privileges may be assigned to customer 102, supplier 104, and/or factory 106 without departing from the scope of the present invention.

Server 114 generates one or more displays containing the information at step 910. This may include, for example, server 114 generating a tree 200 illustrated in FIGS. 2 and 3 or views 400 through 600 illustrated in FIGS. 4 through 6, respectively. Server 114 communicates the display to the user at step 912. This may include, for example, server 114 communicating the display to browser 118.

Although FIG. 9 illustrates one example of a method 900 for providing resource capacity collaboration information to a user, various changes may be made to method 900 without departing from the scope of the present invention. For example, server 114 could provide unrestricted access to the information contained in database 116 without the use of access privileges 140. In this embodiment, server 114 would make the same information available to customer 102, supplier 104, and factory 106.

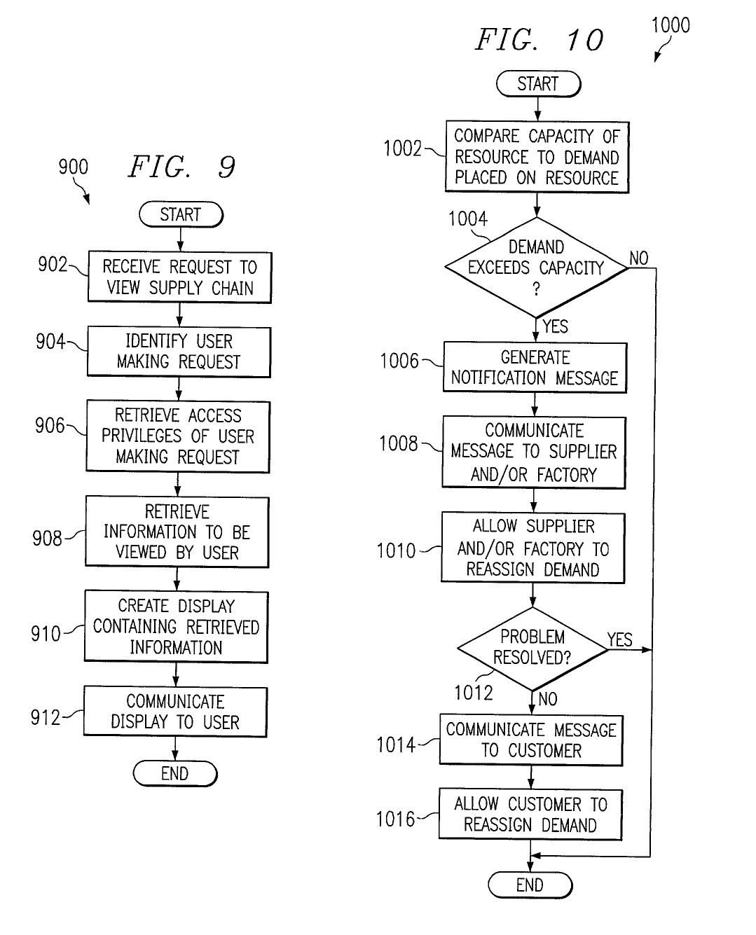

FIG. 10 illustrates another example method 1000 for resource capacity collaboration. Server 114 compares the capacity of a resource 108 to the demand placed on the resource 108 at step 1002. This may include, for example, server 114 accessing assignment information 134 in database 116 to identify a resource 108 assigned to process an item 206 for a customer 102. This may also include server 114 accessing capacity information 136 and demand information 138 in database 116 that are associated with the identified resource 108. In one embodiment, this may further include server 114 identifying any factoring information stored in demand information 138 and using the factoring information to determine the amount of capacity actually consumed by the demand placed on resource 108.

Server 114 determines if the demand placed on the resource 108 exceeds the capacity of resource 108 at step 1004. If the demand does not exceed the capacity of resource 108, method 1000 ends. Resource 108 has enough capacity to meet the demand placed on resource 108. Otherwise, resource 108 lacks capacity to meet the demand placed on resource 108, and server 114 generates a notification message at step 1006. Server 114 communicates the notification message to supplier 104 and/or factory 106 at step 1008. This may include, for example, server 114 displaying a warning message to supplier 104 and/or factory 106 using browser 118. Server 114 allows supplier 104 and/or factory 106 to attempt to reassign at least a portion of the demand to other resources 108 or other production periods at step 1010. This may include, for example, allowing supplier 104 and/or factory 106 to identify another resource 108 that may be used to produce the product for customer 102, or allowing supplier 104 and/or factory 106 to identify another production period during which the resource 108 may produce the product for customer 102. In one embodiment, factory 106 may reassign demand to other resources 108 in that factory 106, and supplier 104 may reassign demand to other factories 106 associated with supplier 104.

Server 114 determines if supplier 104 and/or factory 106 resolved the excessive demand problem at step 1012. This may include, for example, server 114 determining whether the demand placed on resource 108 still exceeds the capacity of resource 108. If the demand does not exceed the capacity of resource 108, supplier 104 and/or factory 106 has resolved the problem, aid method 1000 ends. Otherwise, supplier 104 and/or factory 106 could not reassign enough of the demand to other resources 108. As a result, server 114 communicates the notification message to customer 102 at step 1014. This may include, for example, server 114 displaying a warning message to customer 102 through browser 118. Server 114 allows customer 102 to attempt to reassign at least a portion of the demand to other resources 108 and/or other production periods at step 1016. This may include, for example, allowing customer 102 to identify another resource 108 that may be used to produce the product for customer 102. The other resource 108 may, for example, be a resource 108 of another factory 106 that the initial supplier 104 and/or factory 106 could not access because of their restricted access privileges.

Although FIG. 10 illustrates one example of a method 1000 for resource capacity collaboration, various changes may be made to method 1000 without departing from the scope of the present invention. For example, server 114 could communicate the notification message to customer 102, supplier 104, and factory 106 without waiting to see if supplier 104 and factory 106 could resolve the problem. Also, server 114 could automatically reassign at least a portion of the demand from one resource 108 to another resource 108 or to another production period, rather than waiting for user input. In that case, server 114 may generate notification messages indicating that demand has been reassigned to other resources 108. In addition, while FIG. 10 illustrates server 114 identifying an excessive demand problem in the supply chain, server 114 may identify any other problems in the supply chain.

Although the present invention has been described with several embodiments, a number of changes, substitutions, variations, alterations, and modifications may be suggested to one skilled in the art, and it is intended that the invention encompass all such changes, substitutions, variations, alterations, and modifications that fall within the spirit and scope of the appended claims.

What is claimed is:

1. A method for resource capacity collaboration, comprising:
accessing an assignment of an item used in producing a product for a customer to a first resource of a factory in a first production period;
accessing a capacity value representing a capacity of the first resource to process one or more items in the first production period;
accessing a demand value representing a demand placed on the first resource in the first production period by the assignment of the item to the first resource;
automatically generating a notification if the demand value exceeds the capacity value;
automatically communicating the notification to a user associated with the customer; and
reassigning at least a portion of the demand placed on the first resource in the first production period to at least one of a second resource and a second production period.

2. The method of claim 1, wherein reassigning at least a portion of the demand comprises allowing the user associated with the customer to reassign at least a portion of the demand.

3. The method of claim 2, wherein:
the notification is also automatically communicated to at least one of a user associated with the factory and a user associated with a supplier;
the reassignment is initiated by at least one of the user associated with the factory and the user associated with the supplier, respectively;
the reassignment is to a second resource in the same factory if initiated by the user associated with the factory; and
the reassignment is to a second resource in another factory if initiated by the user associated with the supplier.

4. The method of claim 3, further comprising allowing the user associated with the customer to reassign at least a portion of the demand to another supplier if a reassignment by the user associated with the factory and a reassignment by the user associated with the supplier would both fail to resolve a demand-capacity mismatch associated with the assignment of the item to the first resource.

5. The method of claim 1, wherein the demand value reflects a factoring value associated with processing the item using the first resource, the demand value equaling the factoring value multiplied by a nominal demand value representing a demand that would be placed on the first resource in processing a standard item.

6. The method of claim 1, further comprising:
storing a requested capacity value representing a capacity of the first resource requested by the customer;
storing a committed capacity value representing a capacity of the first resource that at least one of a user associated with the factory and a user associated with a supplier agrees to provide the customer; and
generating a notification when the requested capacity value is different than the committed capacity value.

7. The method of claim 6, further comprising:
storing a contracted capacity value representing a maximum capacity of the first resource that the customer is allowed to request; and
generating a notification when the requested capacity value exceeds the contracted capacity value.

8. The method of claim 1, further comprising:
storing an estimated capacity value representing an estimated capacity of the resource made by the customer; and
generating a notification when the capacity value is different than the estimated capacity value.

9. The method of claim 1, further comprising generating a notification when the capacity value exceeds the demand value.

10. The method of claim 1, wherein the first and second resources are associated with different factories.

11. The method of claim 1, wherein the first and second resources are associated with different suppliers.

12. The method of claim 1, further comprising:
storing at least one access privilege; and
making the assignment, the capacity value, the demand value, and the notification available to a user associated with at least one of the customer, the factory, and a supplier based on the access privilege.

13. The method of claim 1, wherein at least one additional resource is associated with the factory, the additional resource operable to receive and process a second item from the first resource, the method further comprising:
storing a demand value associated with the additional resource, the demand value for the additional resource based at least partially on the demand value for the first resource; and
propagating a change in the demand value for the first resource to the demand value for the additional resource, the change in the demand value for the first resource resulting in a change in the demand value for the additional resource.

14. The method of claim 13, further comprising providing a tree structure to the user in a display, the tree structure comprising the first resource, the additional resource, and at least the demand values for the first resource and additional resource.

15. Software for resource capacity collaboration, the software embodied in at least one computer-readable medium and when executed operable to:
accessing an assignment of an item used in producing a product for a customer to a first resource of a factory in a first production period;
accessing a capacity value representing a capacity of the first resource to process one or more items in the first production period;
accessing a demand value representing a demand placed on the first resource in the first production period by the assignment of the item to the first resource;
automatically generating a notification if the demand value exceeds the capacity value;
automatically communicating the notification to a user associated with the customer; and
reassigning at least a portion of the demand placed on the first resource in the first production period to at least one of a second resource and a second production period.

16. The software of claim 15, wherein the software is operable to allow the user associated with the customer to reassign at least a portion of the demand value.

17. The software of claim 16, further operable to:
automatically communicate the notification to at least one of a user associated with the factory and a user associated with a supplier; and
allow at least one of the user associated with the factory and the user associated with the supplier, respectively, to reassign at least a portion of the demand value to a second resource in the same factory or a second resource in another factory, respectively.

18. The software of claim 17, operable to allow the user associated with the customer to reassign at least a portion of the demand to another supplier if a reassignment by the user associated with the factory and a reassignment by the user associated with the supplier would both fail to resolve a demand-capacity mismatch associated with the assignment of the item to the first resource.

19. The software of claim 15, wherein the demand value reflects a factoring value associated with processing the item using the first resource, the demand value equaling the factoring value multiplied by a nominal demand value representing a demand that would be placed on the first resource in processing a standard item.

20. The software of claim 15, further operable to:
store a requested capacity value representing a capacity of the first resource requested by the customer;
store a committed capacity value representing a capacity of the first resource that at least one of a user associated with the factory and a user associated with a supplier agrees to provide the customer; and
generate a notification when the requested capacity value is different than the committed capacity value.

21. The software of claim 20, further operable to:
store a contracted capacity value representing a maximum capacity of the first resource that the customer is allowed to request; and
generate a notification when the requested capacity value exceeds the contracted capacity value.

22. The software of claim 15, further operable to:
store an estimated capacity value representing an estimated capacity of the resource made by the customer; and
generate a notification when the capacity value is different than the estimated capacity value.

23. The software of claim 15, further operable to generate a notification when the capacity value exceeds the demand value.

24. The software of claim 15, wherein the first and second resources are associated with different factories.

25. The software of claim 15, wherein the first and second resources are associated with different suppliers

26. The software of claim 15, further operable to:
store at least one access privilege; and
make the assignment, the capacity value, the demand value, and the notification available to a user associated with one of the customer, the factory, and the supplier based on the access privilege.

27. The software of claim 15, wherein:
at least one additional resource is associated with the factory, the additional resource operable to receive and process a second item from the first resource; and
the software is further operable to:
store a demand value associated with the additional resource, the demand value for the additional resource based at least partially on the demand value for the first resource; and
propagate a change in the demand value for the first resource to the demand value for the additional resource, the change in the demand value for the first resource resulting in a change in the demand value for the additional resource.

28. The software of claim 27, further operable to provide a tree structure to the user in a display, the tree structure comprising the first resource, the additional resource, and at least the demand values for the first resource and additional resource.

29. A system for resource capacity collaboration, comprising:
a memory operable to store:
an assignment of an item used in producing a product for a customer to a first resource of a factory in a first production period;
a capacity value representing a capacity of the first resource to process one or more items in the first production period;
a demand value representing a demand placed on the first resource in the first production period by the assignment of the item to the first resource; one or more processors collectively operable to:
automatically generate a notification if the demand value exceeds the capacity value;
automatically communicate the notification to a user associated with the customer; and
reassign at least a portion of the demand placed on the first resource in the first production period to at least one of a second resource and a second production period.

30. The system of claim 29, wherein the processors are operable to allow the user associated with the customer to reassign at least a portion of the demand value.

31. The system of claim 30, wherein the processors are further operable to:
automatically communicate the notification to at least one of a user associated with the factory and a user associated with a supplier; and
allow at least one of the user associated with the factory and the user associated with the supplier, respectively, to reassign at least a portion of the demand value to a second resource in the same factory or a second resource in another factory, respectively.

32. The system of claim 31, wherein the processors are operable to allow the user associated with the customer to reassign at least a portion of the demand to another supplier if a reassignment by the user associated with the factory and a reassignment by the user associated with the supplier would both fail to resolve a demand-capacity mismatch associated with the assignment of the item to the first resource.

33. The system of claim 29, wherein the demand value reflects a factoring value associated with processing the item using the first resource, the demand value equaling the factoring value multiplied by a nominal demand value representing a demand that would be placed on the first resource in processing a standard item.

34. The system of claim 29, wherein:
the memory is further operable to:
store a requested capacity value representing a capacity of the first resource requested by the customer; and
store a committed capacity value representing a capacity of the first resource that at least one of a user associated with the factory and a user associated with a supplier agrees to provide the customer; and
the processors are further operable to generate a notification when the requested capacity value is different than the committed capacity value.

35. The system of claim 34, wherein:
the memory is further operable to store a contracted capacity value representing a maximum capacity of the first resource that the customer is allowed to request; and
the processors are further operable to generate a notification when the requested capacity value exceeds the contracted capacity value.

36. The system of claim 29, wherein:
the memory is further operable to store an estimated capacity value representing an estimated capacity of the resource made by the customer; and
the processors are further operable to generate a notification when the capacity value is different than the estimated capacity value.

37. The system of claim 29, wherein the processors are further operable to generate a notification when the capacity value exceeds the demand value.

38. The system of claim 29, wherein the first and second resources are associated with different factories.

39. The system of claim 29, wherein the first and second resources are associated with different suppliers

40. The system of claim 29, wherein:
the memory is further operable to store at least one access privilege; and
the processors are further operable to make the assignment, the capacity value, the demand value, and the notification available to a user associated with one of the customer, the factory, and the supplier based on the access privilege.

41. The system of claim 29, wherein:
at least one additional resource is associated with the factory, the additional resource operable to receive and process a second item from the first resource;
the memory is further operable to store a demand value associated with the additional resource, the demand value for the additional resource based at least partially on the demand value for the first resource; and
the processors are further operable to propagate a change in the demand value for the first resource to the demand value for the additional resource, the change in the demand value for the first resource resulting in a change in the demand value for the additional resource.

42. The system of claim 41, wherein the processor is further operable to provide a tree structure to the user in a display, the tree structure comprising the first resource, the additional resource, and at least the demand values for the first resource and additional resource.

43. A method for resource capacity collaboration, comprising:
accessing an assignment of a particular item used in producing a product for a particular customer to a particular first resource of a particular factory associated with a particular supplier in a first production period, the first resource operable to perform at least one processing step involving the particular item;
accessing a capacity value representing a capacity of the first resource to process one or more items in the first production period;
accessing a demand value representing a demand placed on the first resource in the first production period by the assignment of the particular item to the first resource;
if a demand-capacity mismatch exists with respect to the first resource in that the demand value exceeds the capacity value, automatically generating a notification in response to the demand-capacity mismatch;
automatically communicating the notification to a user associated with the factory, a user associated with the supplier, and a user associated with the customer;
allowing the user associated with the factory to reassign at least a portion of the demand to at least one of a second resource of the same factory and a second production period to attempt to resolve the demand-capacity mismatch;
if the demand-capacity mismatch cannot be fully resolved as a result of reassignment by the user associated with the factory, allowing the user associated with the supplier to reassign at least a portion of the demand to another factory also associated with the supplier to attempt to resolve the demand-capacity mismatch; and
if the demand-capacity mismatch cannot be fully resolved as a result of reassignment by the user associated with the supplier, allowing the user associated with the customer to reassign at least a portion of the demand to another supplier to attempt to resolve the demand-capacity mismatch.

44. Software for resource capacity collaboration, the software being embodied in at least one computer-readable medium and when executed operable to:
access an assignment of a particular item used in producing a product for a particular customer to a particular first resource of a particular factory associated with a particular supplier in a first production period, the first resource operable to perform at least one processing step involving the particular item;
access a capacity value representing a capacity of the first resource to process one or more items in the first production period;
access a demand value representing a demand placed on the first resource in the first production period by the assignment of the particular item to the first resource;
if a demand-capacity mismatch exists with respect to the first resource in that the demand value exceeds the capacity value, automatically generate a notification in response to the demand-capacity mismatch;
automatically communicate the notification to a user associated with the factory, a user associated with the supplier, and a user associated with the customer;
allow the user associated with the factory to reassign at least a portion of the demand to at least one of a second resource of the same factory and a second production period to attempt to resolve the demand-capacity mismatch;
if the demand-capacity mismatch cannot be fully resolved as a result of reassignment by the user associated with the factory, allow the user associated with the supplier to reassign at least a portion of the demand to another factory also associated with the supplier to attempt to resolve the demand-capacity mismatch; and
if the demand-capacity mismatch cannot be fully resolved as a result of reassignment by the user associated with the supplier, allow the user associated with the customer to reassign at least a portion of the demand to another supplier to attempt to resolve the demand-capacity mismatch.

45. A system for resource capacity collaboration, comprising:
a memory operable to store:
an assignment of a particular item used in producing a product for a particular customer to a particular first resource of a particular factory associated with a particular supplier in a first production period, the first resource operable to perform at least one processing step involving the particular item;
a capacity value representing a capacity of the first resource to process one or more items in the first production period;
a demand value representing a demand placed on the first resource in the first production period by the assignment of the particular item to the first resource;
one or more processors collectively operable to:
if a demand-capacity mismatch exists with respect to the first resource in that the demand value exceeds the capacity value, automatically generate a notification in response to the demand-capacity mismatch;
automatically communicate the notification to a user associated with the factory, a user associated with the supplier, and a user associated with the customer;
allow the user associated with the factory to reassign at least a portion of the demand to at least one of a second resource of the same factory and a second production period to attempt to resolve the demand-capacity mismatch;
if the demand-capacity mismatch cannot be fully resolved as a result of reassignment by the user associated with the factory, allow the user associated with the supplier to reassign at least a portion of the demand to another factory also associated with the supplier to attempt to resolve the demand-capacity mismatch; and
if the demand-capacity mismatch cannot be fully resolved as a result of reassignment by the user associated with the supplier, allow the user associated with the customer to reassign at least a portion of the demand to another supplier to attempt to resolve the demand-capacity mismatch.

46. A method for resource capacity collaboration, comprising:
accessing an estimated capacity value representing a customer-estimated capacity of a first resource of a factory used in producing a product for the customer, the first resource operable to perform at least one, processing step in producing the product;
accessing a contracted capacity value representing a maximum capacity of the first resource that the customer is allowed to request;
accessing a requested capacity value representing a capacity of the first resource requested by the customer to be used in producing the product for the customer;
accessing a committed capacity value representing a capacity of the first resource that at least one of a user associated with the factory and a user associated with a supplier agrees to provide the customer;
accessing an assignment of an item used in producing the product to the first resource;
accessing a capacity value representing a capacity of the first resource to process one or more items in a first production period;
accessing a demand value representing a demand placed on the first resource in the first production period by the assignment of the item to the first resource;
automatically generating a notification in response to a circumstance selected from the group consisting of:
the requested capacity value being different than the committed capacity value;
the requested capacity value exceeding the contracted capacity value;
the capacity value being different than the estimated capacity value; and
the capacity value exceeding the demand value;
automatically communicating the notification to a user associated with the customer, the user associated with the supplier, and the user associated with the factory; and
allowing at least one of the users to resolve the circumstance in response to the notification.

47. Software for resource capacity collaboration, the software being embodied in at least one computer-readable medium and when executed operable to:
access an estimated capacity value representing a customer-estimated capacity of a first resource of a factory used in producing a product for the customer, the first resource operable to perform at least one processing step in producing the product;
access a contracted capacity value representing a maximum capacity of the first resource that the customer is allowed to request;
access a requested capacity value representing a capacity of the first resource requested by the customer to be used in producing the product for the customer;
access a committed capacity value representing a capacity of the first resource that at least one of a user associated with the factory and a user associated with a supplier agrees to provide the customer;
access an assignment of an item used in producing the product to the first resource;
access a capacity value representing a capacity of the first resource to process one or more items in a first production period;
access a demand value representing a demand placed on the first resource in the first production period by the assignment of the item to the first resource;
automatically generate a notification in response to a circumstance selected from the group consisting of:
the requested capacity value being different than the committed capacity value;
the requested capacity value exceeding the contracted capacity value;
the capacity value being different than the estimated capacity value; and
the capacity value exceeding the demand value;
automatically communicate the notification to a user associated with the customer, the user associated with the supplier, and the user associated with the factory; and
allow at least one of the users to resolve the circumstance in response to the notification.

48. A system for resource capacity collaboration, comprising:
a memory operable to store:
an estimated capacity value representing a customer-estimated capacity of a first resource of a factory used in producing a product for the customer, the first resource operable to perform at least one processing step in producing the product;
a contracted capacity value representing a maximum capacity of the first resource that the customer is allowed to request;
a requested capacity value representing a capacity of the first resource requested by the customer to be used in producing the product for the customer;
a committed capacity value representing a capacity of the first resource that at least one of a user associated with the factory and a user associated with a supplier agrees to provide the customer;
an assignment of an item used in producing the product to the first resource;
a capacity value representing a capacity of the first resource to process one or more items in a first production period;
a demand value representing a demand placed on the first resource in the first production period by the assignment of the item to the first resource;
one or more processors collectively operable to:
automatically generate a notification in response to a circumstance selected from the group consisting of the requested capacity value being different than the committed capacity value, the requested capacity value exceeding the contracted capacity value, the capacity value being different than the estimated capacity value, and the capacity value exceeding the demand value;
automatically communicate the notification to a user associated with the customer, the user associated with the supplier, and the user associated with the factory; and
allow at least one of the users to resolve the circumstance in response to the notification.
